(19) United States
(12) Patent Application Publication
(10) Pub. No.: US 2006/0003844 A1
(43) Pub. Date: Jan. 5, 2006

(54) Video Device mounted on a person

(76) Inventor: Jonathan James Marquis, Winchester (GB)

Correspondence Address: Christopher J. Whewell;Western Patent Group, 6020 Tonkowa Trail, Georgetown, TX, 78628, US

(21) Appl. No.: 10/882,809

(22) Filed: Jul. 2, 2004

(51) Int. Cl. A63F 13/00

(52) U.S. Cl. 463/46

(57) ABSTRACT

A housing system for a video device including a screen is described, which is mounted on a person. The enclosure housing the screen is elastically suspended within a deformable frame to protect it from impact damage. Within the enclosure a flexible electromagnetic shield surrounds at least the sides of the screen.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

This invention pertains to the field of multi-media electronics, and in particular to housing portable video and game playing devices.

The Prior Art concerning portable video and game playing devices, referred to below, are concerned with mounting methods to enable portability; but they do not address other issues resulting from that portability, such as the need to protect against damage and providing light weight electromagnetic shielding around the electronics.

Japanese patent JP 2000 298445 A (MAEDA MITSUMASA) 24 Oct. 2000 describes a system including a video screen mounted on a person; however no features are described to protect the screen from mechanical damage either when being worn or when being mounted or dismounted.

U.S. Pat. No. 5,912,653 (Fitch, Stephan J) 29 Jul. 1997 describes a system including a flexible screen embedded in a garment; flexible screens are generally still in development and not launched into economic mass production. Video screens for some time into the future will still be rigid. Rigid screens will break if mechanical forces above a certain limit act upon them.

This invention addresses the equipment's mechanical and electromagnetic protection issues brought about by the portability of such video and game playing devices. The portable environment requires weight to be a minimum, and this invention takes this factor fully into account.

### BRIEF SUMMARY OF THE INVENTION

This invention is a housing system which, when applied to a portable video or game playing device, provides superior protection while adding little weight.

The system comprises a deformable peripheral frame in which a screen within it's enclosure is suspended. The screen's enclosure position within the peripheral frame is movable, relative to the frame, due to the springs used to form the suspending links between the two items.

Impacts to the unit will most likely apply force to the peripheral frame first, because they would act from the outside.

Upon an impact to the frame taking place, the force being applied to the frame will begin deformation. The frame deformation will absorb impact energy, extend the duration over which the impact occurs, and therefore lessen the acceleration applied to the screen.

If the impact force is small the deformation will be elastic and the frame will return to its original shape. If the impact force is large enough, the frame deformation will pass the yield point and become permanently deformed.

The screen enclosure can move and adjust within the deformed frame to a central position determined by the equalising forces of the spring suspending links. The frame may be deformed in x, y and z planes.

In the case of forces being applied from the sides, side buffers located on the frame protect the device from small knocks and abrasions.

If impact forces applied are large enough to cause frame deformation, the addition of the malleable buffer will further extend the deformation time of the peripheral frame, both effects lead to a much reduced acceleration being applied to the screen.

Furthermore, the side buffers curved surface affords a keying surface for game player and general user interface controls (which have a curved underside) to be located onto, for retention while not being used. A magnetic fixing solution could for example hold the user control in place on the side buffer.

For this housing system to be easily carried, the weight of the screen enclosure needs to be a minimum. While electromagnetic shielding is easily achievable with full metal construction, this does not result in a structure that can tolerate elastic deformation, which could occur in a portable device.

In one embodiment of this invention, only a thin metal foil is required to shield the area between the peripheral edge of the screen and metal back plate.

A further benefit for this construction method is that the same foil shield can also provide, if suitable materials are used, protection against water ingress.

### BRIEF DESCRIPTION OF THE SEVERAL VIEWS OF THE DRAWING

FIG. 1—depicts one embodiment of the invention in an arrangement of screen 1 within an enclosure formed by C channel element 12 which is elastically suspended within peripheral frame 2 by springs 3 on guides 4.

FIG. 2—depicts an embodiment of an elastic suspension point. The screen enclosure's C channel element 12 is shown elastically connected with peripheral frame 2 by spring 3 and guide 4.

FIG. 3—depicts an embodiment of a malleable side buffer 5 located on the peripheral frame 2.

FIG. 4A—depicts one embodiment of the lightweight foil electromagnetic shield 8 joining between the screen metal surround 6 and the metal backplate 7.

FIG. 4B—depicts a cross section view (not shaded for clarity) of the screen metal surround 6 and metal backplate locating into the C channel element 12.

FIG. 5—depicts one embodiment of the mounting location of a game player hand held user interface device 9 on the side buffer 5.

FIG. 6—depicts a cross-sectional view (not shaded for clarity) of one embodiment of a fixing method for the game player user interface device 9 to the side buffer 5 by means of two magnets. One magnet 10 is fitted to the interface device and one magnet 11 is fitted to the side buffer 5.

### DETAILED DESCRIPTION OF THE INVENTION

Although housings exist for LCD Monitors already, they generally are for static operation and afford no protection to the screen over enclosing it with a plastic or metal outer molding. Any impact upon the enclosure surface is mechanically coupled directly to the screen within. Electromagnetic shielding is provided by a folded metal sheet, within the outer molding, to shield the sides and rear of the screen.

The invention set forth here, allows the manufacture of a lightweight screen enclosure because it firstly protects the enclosure from direct forces and secondly makes use of a lightweight electromagnetic shielding alternative to folded metal sheet.

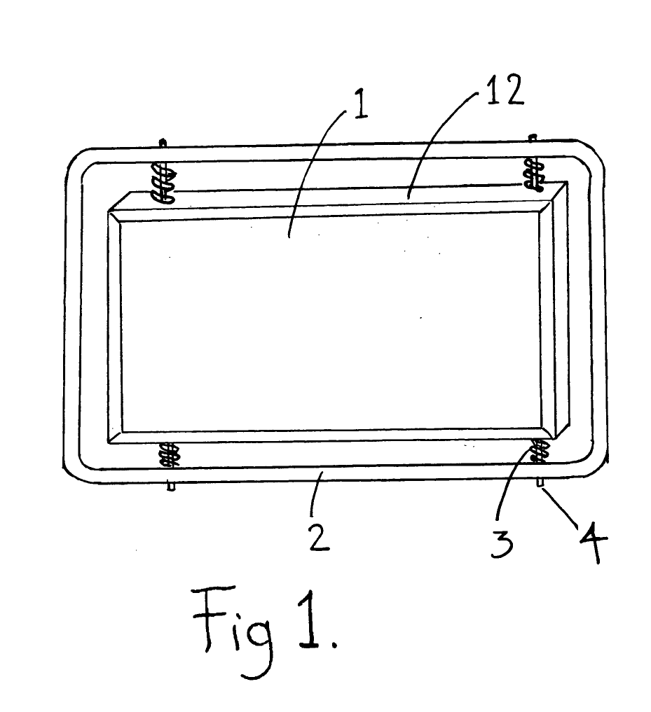

Surrounding the screen's enclosure, shown in FIG. 1, is a peripheral frame 2 which is made from lightweight metal such as copper alloy or aluminium. These materials are suited to the application since they will deform and absorb impact energy within the general range of forces that typically would result from a drop impact to ground of a Video or Game Playing Device, typically weighing about 6 Kg.

The frame does not need to surround all sides of the device, it could for example be decided to only protect the lower side of the device. The frame could be made up from multiple parts or formed as one continuous element.

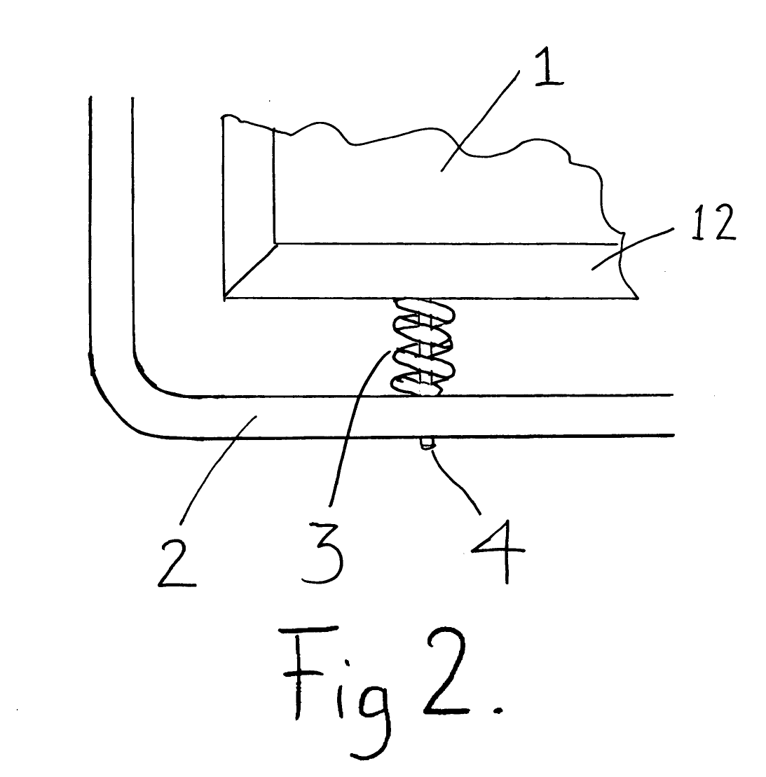

Referring to FIG. 2, there must be sufficient gap between the peripheral frame 2 and the screen enclosure sides 12 to allow frame deformation to take place. A dimension over 25 mm is preferred.

The frame would, for small impact forces, deform elastically and so return to its original form once the force was removed. For larger impact forces the deformation would pass the yield point of the metal frame and the deformation would be permanent, necessitating repair or replacement of the frame.

A screen within an enclosure is elastically suspended within the peripheral frame, detail of one suspension point is shown in FIG. 2. The suspension allows the frame to change shape in x, y and z planes, while exerting only low forces on the screen housing. The spring guide 4 is composed of a brittle, or flexible material, such as polypropylene, to either break or bend at low force levels, so that it can not couple any significant external forces directly to the screen's enclosure.

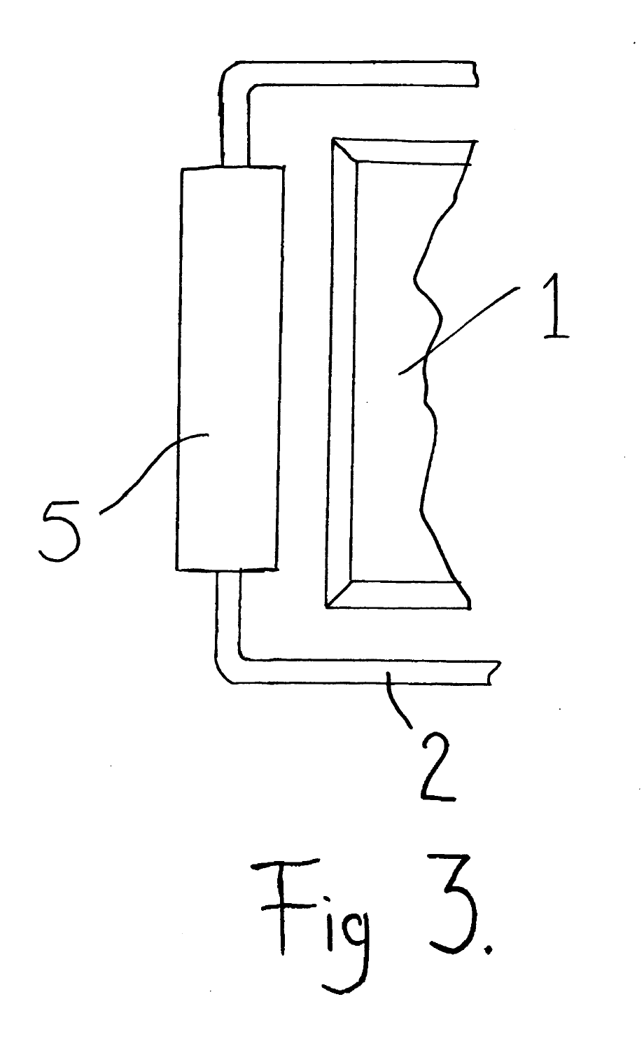

FIG. 3 illustrates a side buffer formed of a malleable material, such as expanded polyethylene, mounted on a side vertical element of the peripheral frame 2 for additional protection from side impacts and abrasion.

Side buffers could be located on both side vertical frame elements and on the top and bottom horizontal frame elements to improve further the impact absorbing benefit of the peripheral frame.

Electronic apparatus must, in addition to other safety regulations, comply with electromagnetic emission and susceptibility regulations such as for example laid down by the Federal Communications Commission in North America and European Council Directives in Europe.

Screen enclosures for desktop LCD Monitors have no major weight concerns and they achieve the electromagnetic shielding through the use of folded metal sheet which is effective and low cost to achieve the objective.

For a portable device electromagnetic shielding is also required but weight is important to minimise.

An enhancement may be applied to better meet the operating environment of this invention whereby not only the peripheral frame but also the screen enclosure has a degree of flexibility. In this case the shielding within the enclosure must also flex and not become damaged during elastic deformations of the screen's enclosure.

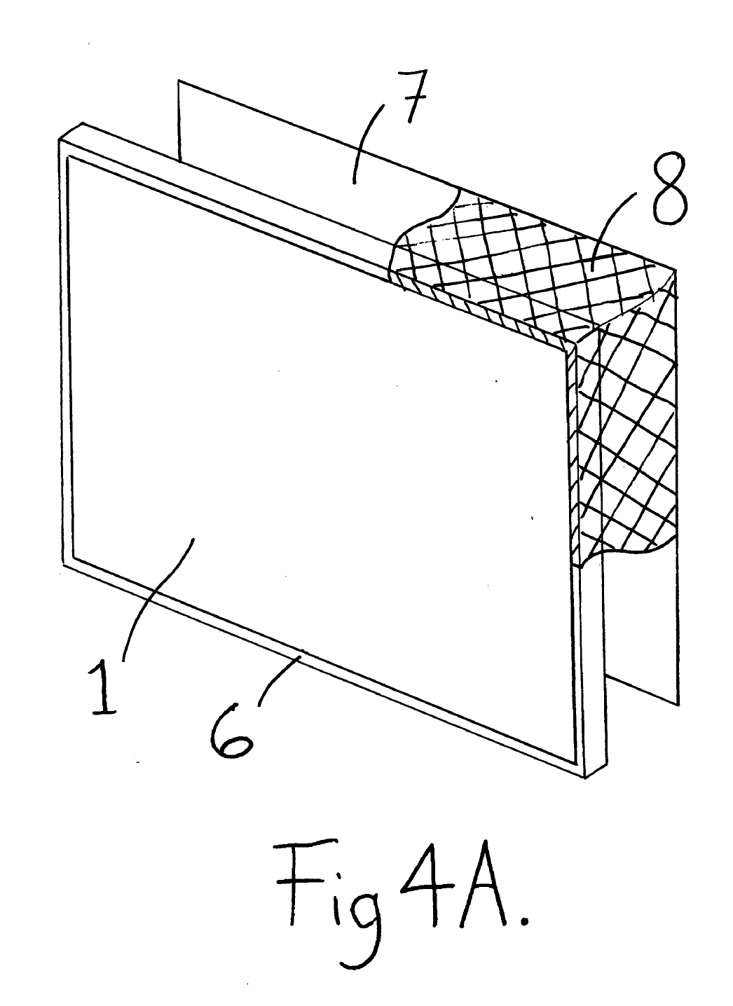

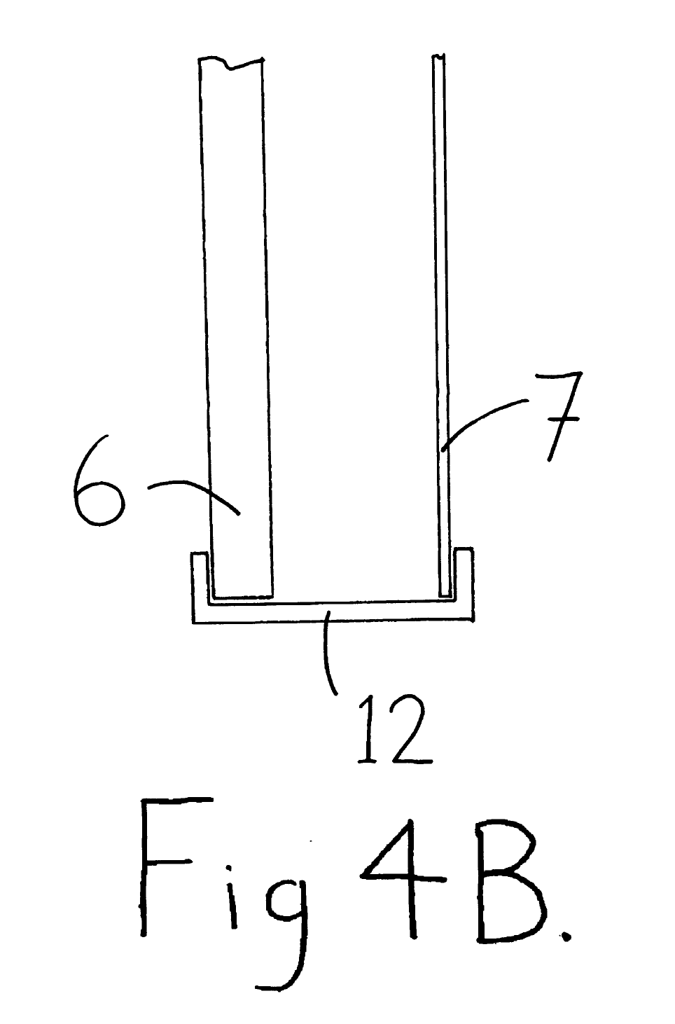

The housing invention described here solves the shielding requirement by use of a thin metal foil shield 8 depicted in FIG. 4A which joins between the metal conductive edge 6 of the screen and the metal back plate 7 of the screen enclosure. The thin metal foil may for example be made from copper and be coated with acrylic permanent adhesive loaded with conductive silver particles. A C-section channel 12 covers the foil shield and forms the edge of the screen enclosure (shown in FIG. 4B).

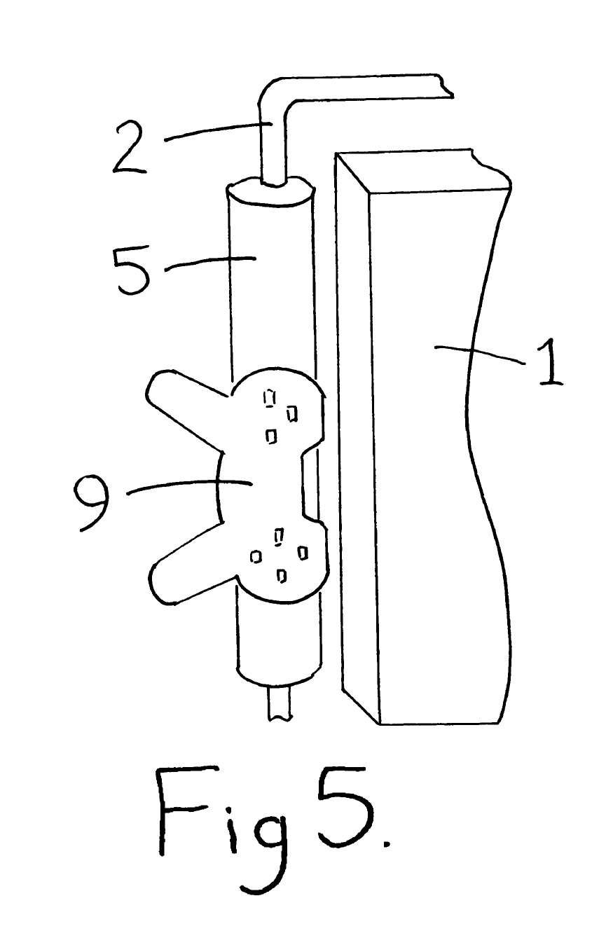

Side buffers, as shown in FIG. 5, can serve a dual purpose in the case of applications where user interface control(s) are required, where they provide a fixing location for the user interface to be stored. Two fixing locations could be provided, for two user interface controls, one on each side of the housing.

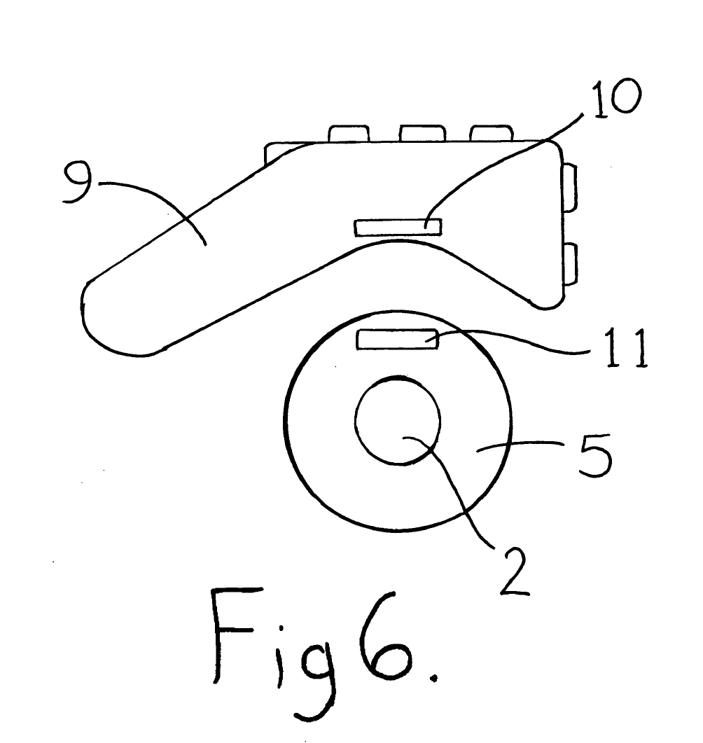

FIG. 6 depicts one embodiment where the fixing method is magnetic, a magnet 11 embedded in the side buffer 5 attracts the magnet 10 fixed on or in the user interface control 9 to hold it in place. Strong magnets would be used ensuring the user interface control 9 would not fall off, and yet would allow a user to detach a control when required.

While the exemplary embodiments illustrated in the Figs and described above are presently preferred, it should be understood that these embodiments are offered by way of example only. Accordingly, the present invention is not limited to a particular embodiment, but extends to various modifications that nevertheless fall within the scope of the appended claims.

1) A video display device combination which comprises:
a) a screen enclosure having a plurality of sides, and further comprising a screen;
b) a deformable peripheral frame having a plurality of sides;
said peripheral frame being disposed about said screen enclosure sufficiently to define a gap between said peripheral frame and said screen enclosure; and
c) connective means for coupling said peripheral frame to said enclosure,
said connective means comprising a plurality of springs on guides disposed within said gap.

2) A device as described in claim 1 wherein the screen enclosure is elastically suspended within said peripheral frame.

3) A device as described in claim 1 further comprising:
d) malleable side-buffers fixed to the peripheral frame.

4) A device as described in claim 1 wherein the screen within the enclosure is electromagnetically shielded by means of a flexible conductive shield.

5) A video display device housed in an enclosure surrounded on at least one side by a deformable peripheral frame and further comprising malleable side-buffers fixed to the peripheral frame protect the device from side impacts, wherein human interface control(s) are detachably magnetically mounted on a curved surface portion of the side buffer(s).

6) A device according to claim 1 wherein said gap is at least 25 millimeters.

7) A device according to claim 1 wherein the position of said screen enclosure is moveable within said peripheral frame.

8) In an electronic display screen surrounded by a substantially-rectangular enclosure having an outer perimeter which is intended for use in non-stationary employments, wherein the improvement comprises providing a substantially-rectangular peripheral frame having an interior perimeter, which surrounds said enclosure so as to define a gap therebetween, and is attached thereto by a plurality of connective means which each comprise a spring and guide combination, said connective means being disposed within said gap.
